(19) United States
(12) Patent Application Publication
(10) Pub. No.: US 2007/0174878 A1
(43) Pub. Date: Jul. 26, 2007

(54) System and method for purchasing and viewing digital content from physical media

(76) Inventor: Pete Tenereillo, 7992 Paseo Esmerado Carlsdad, CA (US)

Correspondence Address: MINTZ, LEVIN, COHN, FERRIS, GLOVSKY AND POPEO, P.C, LA JOLLA CENTRE II, 9255 TOWNE CENTRE DRIVE, SUITE 600, SAN DIEGO, CA, 92121-3039, US

(21) Appl. No.: 11/543,018

(22) Filed: Oct. 3, 2006

Related U.S. Application Data
(60) Provisional application No. 60/734,387, filed on Nov. 7, 2005.

(51) Int. Cl. H04N 7/173

(52) U.S. Cl. 725/86

(57) ABSTRACT

A system and method for purchasing, viewing and reselling digital media content are disclosed. A purchasing user can request to purchase at least one digital medium having stored thereon the digital media content, the at least one digital medium being maintained in a physical media library. The digital media content of the at least one digital medium is read using a media player connected with the physical media library. The digital media content is then transmitted via a network from a media server to the purchasing user. The purchasing user can resell the at least one digital medium back to the subscription service.

### RELATED APPLICATION

The present patent application claims priority under 35 U.S.C. 119 to U.S. Provisional Patent Application Ser. No. 60/734,387, filed on Nov. 7, 2005, and entitled, “System For The Purchase, Remote Viewing, and Sale of DVD Movies” the entire disclosure of which is incorporated by reference herein.

### BACKGROUND

Digital video disks (DVDs) are an ubiquitous medium by which consumers watch videos. Besides a direct purchase of a DVD, which for consumers can become expensive, popular ways to watch DVDs include a DVD rental service, such as from a store or via a mail service. However, such services are inefficient and expensive, and there is a risk of a user running afoul of copyright or other legal protections established for owners of digital media content and the physical embodiments thereof.

### SUMMARY

A digital media content store includes a purchase and viewing system. In one aspect, the system includes a server providing a web service, the web service including an on-line store, and a physical media library containing physical digital media that are associated with the on-line store. The system further includes a network connected with the physical media library, and a media server that transmits the digital media content over the network from a purchased digital medium selected from the physical media library.

In another aspect, a system for facilitating the purchase and viewing of digital media content includes a server providing a web service, the web service including a subscription service and an on-line store, and a physical media library having physical units of digital media that are associated with purchases of a user of the on-line store, the user being registered via the subscription service. The system further includes a media server that transmits the digital media content from a purchased digital medium selected from the physical media library to the user via a network.

In yet another aspect, a method for purchasing and viewing digital media content includes steps of executing a request from a purchasing user to purchase at least one digital medium having stored thereon the digital media content, the at least one digital medium being maintained in a physical media library. The method further includes steps of reading the digital media content of the at least one digital medium using a media player connected with the physical media library, and transmitting the read digital media content via a network from a media server to the purchasing user.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a system that facilitates the purchase, view, and resale of digital media.

FIG. 2 is a flowchart of a method for purchasing and viewing digital media.

Like reference symbols in the various drawings indicate like elements.

### DETAILED DESCRIPTION

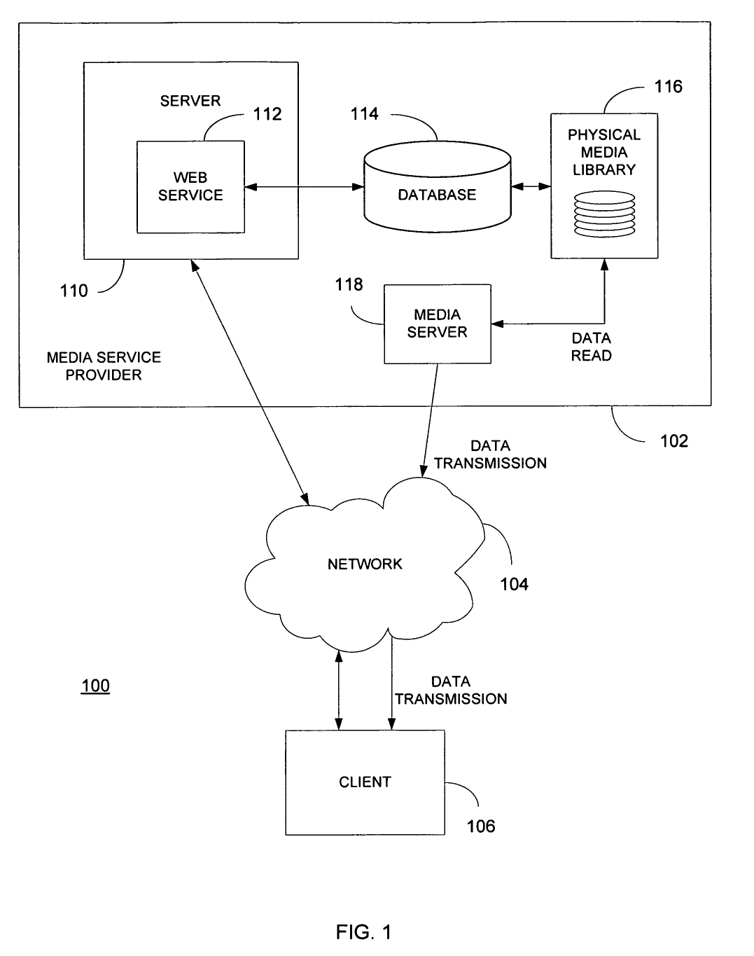

FIG. 1 is a block diagram of a system 100 that facilitates the purchase, view, and resale of digital content. Digital content is composed of data that is recorded onto a physical medium, such as a digital video disk (DVD), although other physical media can be used with the system 100. Further, the digital content is preferably video data, but can be other types of content such as audio data and graphical data. For clarity, and without intending to limit the description to only the preferred embodiments described herein, the system 100 facilitates the purchase, view and resale of the content stored on DVDs.

The system 100 includes a media service provider 102 that communicates through one or more networks 104 with one or more clients 106. The one or more networks 104 can include any type of communication network such as any broadband wired or wireless communication network, and preferably embodies what is known as the Internet. Each of the one or more clients 106 can be a personal computer or home entertainment center operating in a home or place of residence of a subscriber. The client 106 can include, without limitation, working memory such as random access memory (RAM) and read-only memory (ROM), a disk drive or other long-term archival or persistency storage, and one or more processors. The client 106 can also use locally-stored or web-based application software, such as a browser or a media player program.

The media service provider 102 can be an entity such as a corporate entity housed in a building, or may be embodied in one or more computers. The media service provider 102 can also include services such as accounting, billing, customer service, technical assistance, etc., but for purposes of this description the media service provider 102 is primarily configured to store subscriber information, handle physical copies of digital media, and communicate digital content from the digital media to the one or more clients.

The media service provider 102 includes a web server 110 that hosts a web service 112. The web service 112 executes processes for accepting, validating and establishing subscriptions for a subscriber associated with a client 106. Subscriber information, such as identity, address, billing information, and subscriber transactional history information, is stored in a database 114. Subscriber purchases of DVDs are associated with physical copies of DVDs in a physical media library 116. The physical media library 116 can include a media player for playing the DVDs, including such implements and equipment such as processors and jukeboxes.

The web service 112 also executes an on-line store in which a subscriber can purchase a DVD that is never physically shipped to the subscriber, but rather kept in the physical media library 116. DVDs that are then owned by a subscriber can be viewed by that subscriber as follows: a media server 118 reads or receives the digital data from a DVD from the physical media library 116, and transmits the digital data or content through the network 104 to the client 102 using any of a number of digital data transmission methods.

The subscriber may sell a purchased DVD back to the media service provider 102, via the web service's 112 on-line store or other information exchange interface. In some implementations, there is no limit to the number of times a subscriber may buy and sell any particular DVD, and the buying, selling and viewing processes are automated via the interface between the client 106 and the media service provider 102. In other implementations, limits of buying and selling can be set.

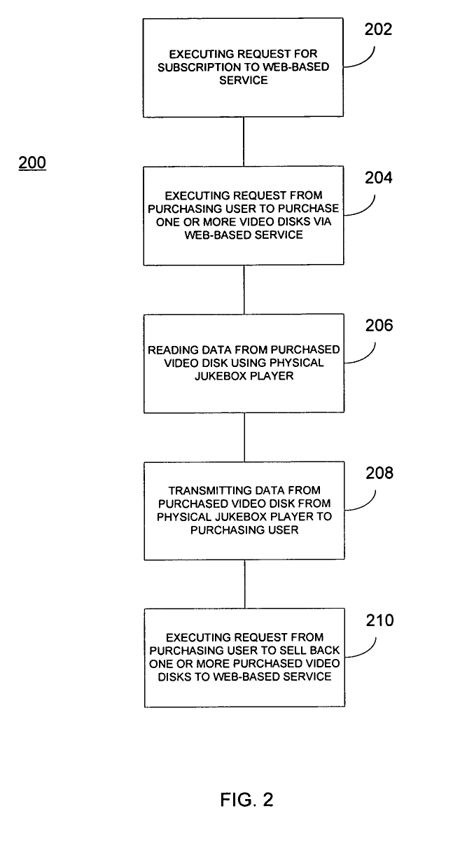

FIG. 2 is a flowchart of a method for purchasing and viewing digital media, as can be executed by the system 100 shown in FIG. 1, and in particular by the media service provider 102 alone or in the cooperation of a client 106 communicating via a network 104. At 202, a request for a subscription to a web-based DVD purchasing and viewing service is executed. A subscriber creates an account, subscriber information such as identity and address is verified, and then the subscriber is allowed to log on to and access an on-line store in which the subscriber can select for purchase any number of DVDs.

At 204, a request from a purchasing user of the system is received and executed, in which the purchasing user purchases one or more DVDs via the web-based service. At 206, information from a purchased DVD is read or received by a media server from a physical media library, including some form of jukebox player mechanism. At 208, data or content from the purchased DVD is streamed to the purchasing user via one or more networks and to a client device such as a personal computer or entertainment system.

At 210, a request from the purchasing user to sell back one or more purchased DVDs to the web-based service is executed. Accordingly, the purchasing user or subscriber can buy and sell any number of DVDs, while having a right to view DVD they have purchased as many times as they desire until they sell that DVD back to the media service provider via the web-based service.

In addition (or as an alternative) to the purchase of one or more DVDs from the media service provider, the purchasing user may physically submit (e.g. via mail) to the media service provider one or more DVDs that they already own for sale to another user or subscriber of the system. The media service provider may choose to purchase DVDs from users for its own stock, but those DVDs will not be rented or otherwise viewed by users until they are sold. The system and method described herein eliminates the wait time and inefficiencies associated with mail-based DVD sharing services, and reduces the expense to the user associated with renting DVDs. The process does not create or store electronic copies of the DVDs. Revenue models potentially include advertising revenue, initial sale of DVDs, commission on DVD sale transactions, and a straight subscription fee.

Embodiments of the invention and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A system for facilitating the purchase and viewing of digital media content, the system comprising:
a server providing a web service, the web service including a subscription service and an on-line store;
a physical media library having physical units of digital media that are associated with purchases of a user of the on-line store, the user being registered via the subscription service; and
a media server that transmits the digital media content from a purchased digital medium selected from the physical media library to the user via a network.

2. A system in accordance with claim 1, wherein the digital media includes digital video disks (DVDs), and wherein the purchased digital medium is a DVD.

3. A system in accordance with claim 1, further comprising a database storing a purchase history of the user.

4. A system in accordance with claim 3, wherein the physical media library includes a media player that is responsive to the purchase history of the user.

5. A system in accordance with claim 1, further comprising a client, operable by the user, for receiving and displaying the streamed digital media content.

6. A system in accordance with claim 5, wherein the network includes the Internet and the client includes a browser application.

7. A system in accordance with claim 1, wherein the web service is further configured to buy a purchased digital medium from the user.

8. A system in accordance with claim 1, wherein the subscription service includes one or more software modules executing on a computer processor.

9. A system in accordance with claim 1, wherein the web service includes one or more software modules executing on a computer processor.

10. A system in accordance with claim 9, wherein server includes the computer processor.

11. A method for purchasing and viewing digital media content, the method comprising:
executing a request from a purchasing user to purchase at least one digital medium having stored thereon the digital media content, the at least one digital medium being maintained in a physical media library;
reading the digital media content of the at least one digital medium using a media player connected with the physical media library; and
transmitting the read digital media content via a network from a media server to the purchasing user.

12. A method in accordance with claim 11, further comprising executing a request by the purchasing user to subscribe for access to the physical media library via a web-based service.

13. A method in accordance with claim 11, wherein the at least one digital medium includes a digital video disk (DVD).

14. A method in accordance with claim 11, further comprising displaying the streamed digital media content on a client device.

15. A digital media content system, comprising:
a server providing a web service, the web service including an on-line store;
a physical media library containing physical digital media that are associated with the on-line store;
a network connected with the physical media library; and
a media server that transmits the digital media content over the network from a purchased digital medium selected from the physical media library.

16. A system in accordance with claim 15, further comprising a database storing a purchase history of users of the system.

17. A system in accordance with claim 16, wherein the physical media library includes a media player that is responsive to the purchase history of a user.

18. A system in accordance with claim 15, wherein the network includes the Internet and the client includes a browser application.
